(19) United States
(12) Patent Application Publication
(10) Pub. No.: US 2005/0220516 A1
(43) Pub. Date: Oct. 6, 2005

(54) Waste toner container and electrophotographic image forming apparatus having the waste toner container

(75) Inventors: Jin-soo Lee, Suwon-si (KR); Young-min Yoon, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/037,241

(22) Filed: Jan. 19, 2005

(30) Foreign Application Priority Data
Mar. 31, 2004 (KR) 2004-22029

(51) Int. Cl. G03G 21/12

(52) U.S. Cl. 399/360

(57) ABSTRACT

A waste toner container for an electrophotographic image forming apparatus has a housing to collect waste toner. A flange extends outwardly from the housing, and a waste toner inlet is disposed at an end of the flange to facilitate waste toner flow therethrough. A plug disposed in the housing is elastically biased in the direction of closing the waste toner inlet.

### CROSS-REFERENCE TO RELATED APPLICATION

This application claims the benefit under 35 U.S.C. § 119(a) of Korean Pate Application No. 2004-22029, filed on Mar. 31, 2004, in the Korean Intellectual Property Office, the entire disclosure of which is hereby incorporated by reference.

### FIELD OF THE INVENTION

The present invention relates to an electrophotographic image forming apparatus. More particularly, the present invention relates to a waste toner container for an electrophotographic image forming apparatus.

### DESCRIPTION OF RELATED ART

In general, an electrophotographic image forming apparatus is an apparatus for forming a single-colored or multi-colored image by performing a light scanning operation on a photoconductor charged with a uniform electric potential to form an electrostatic latent image, developing the electrostatic latent image with a developing agent having a color by using a developer, and transferring and fusing the developed image to a paper. The electrophotographic image forming apparatus may be categorized into a dry type and a wet type. The dry type electrophotographic image forming apparatus uses a powder toner as the developing agent, unlike the wet type electrophotographic image forming apparatus that uses a wet type developing agent where toner powders are dispersed in liquid carrier. In general, the dry type electrophotographic image forming apparatus requires four developers having toners of four colors such as cyan C, magenta M, yellow Y, and blue K in order to form a color image.

Waste toner, which is not transferred and affixed to a paper during an image forming process of the image forming apparatus, remaining on the photoconductor or intermediate transfer medium of the image forming apparatus causes degradation in print quality. Therefore, waste toner should be removed from the photoconductor or intermediate transfer medium by cleaning means and collected in a waste toner container.

FIG. 1 is a perspective view showing an example of an image forming apparatus having a conventional waste toner container.

A conventional image forming apparatus 10 has a detachable waste toner container 30 on its front. The waste toner container 30 is mounted in a concave waste toner container holding portion 12 that is visible when a front door 11 of the image forming apparatus 10 is opened. The waste toner container holding portion 12 has first and second outlets that are closed by first and second cap units 21 and 23, respectively. Waste toner carried from a photoconductor (not shown) is discharged from the first outlet, and waste toner from an intermediate transfer medium (not shown) is discharged from the second outlet.

The waste toner container 30 has a space for the waste toner, and first and second openings 31 and 35 into which the waste toner flows. First and second flanges 32 and 36 are provided around the first and second openings 31 and 35. When the waste toner container 30 is attached to the waste container holding portion 12, the first and second flanges 32 and 36 push back the first and second cap 21 and 23, respectively, to open the first and second outlets, whereby the waste toner produced in the image forming apparatus 10 is collected in the waste toner container 30.

Conventionally, when the waste toner container 30 is filled with the waste toner, a user separates the waste toner container 30 from the waste toner container holding portion 12, closes the first and second openings 31 and 35 with plugs 38 and 39 to prevent the waste toner from discharging, and disposes the waste toner container 30.

However, since the first and second openings 31 and 35 are opened before closing with the plugs 38 and 39, the waste toner in the waste toner container 30 may be discharged in the process of separating the waste toner container 30 from the waste toner container holding portion 12 and closing the first and second openings 31 and 35 with plugs 38 and 39. The discharged waste toner may contaminate the image forming apparatus 10, causing malfunction of the apparatus 10, degradation of print quality, environmental pollution, and adverse effects on health when the waste toner is inhaled through a respiratory organ.

Accordingly, there is a need for a waste toner container for an electrophotographic image forming apparatus that substantially prevents discharge of toner when separating the waste toner container from the waste toner container holding portion.

### SUMMARY OF THE INVENTION

The present invention provides a waste toner container and an electrophotographic image forming apparatus having the waste toner container capable of preventing waste toner from discharging by automatically closing an inlet of the waste toner container.

According to an aspect of the present invention, a waste toner container has a housing that has a volume to collect waste toner. Waste toner flows into the housing through a waste toner inlet that is positioned at an end of a. A plug is disposed in the housing and is elastically biased in the direction of closing the waste toner inlet.

The plug may be guided in the housing by guide means. The guide means may include a guide protrusion and a guide hole. The guide protrusion may be projected from the vicinity of the waste toner inlet to the inside of the housing. The guide hole may be located on the plug and passed through by the guide protrusion.

The plug may be elastically biased by a coil spring in the housing.

The housing may include a pair of waste toner inlets into which waste toner flows through different paths, and a pair of plugs that are elastically biased in the direction of closing the pair of waste toner inlets.

According to another aspect of the present invention, an electrophotographic image forming apparatus has a waste toner container to collect waste toner that is not transferred to a printing medium during a print process. The waste toner container includes a housing that has a volume to collect waste toner. Waste toner flows into a waste toner inlet positioned at an end of a flange projecting from the housing. A plug is disposed in the housing and is elastically biased in the direction of closing the waste toner inlet.

The plug may be guided in the housing by guide means.The guide means may include a guide protrusion and a guide hole. The guide protrusion may be projected from the vicinity of the waste toner inlet to the inside of the housing.The guide hole may be located on the plug and passed through by the guide protrusion.

The plug may be elastically biased by a coil spring in the housing.

The housing may include a first waste toner inlet into which waste toner removed from a photoconductor flows and a second waste toner inlet into which waste toner removed from an intermediate transfer medium flows.First and second plugs are disposed in the housing and are elastically biased in the direction of closing the first and second waste toner inlets.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of an electrophotographic image forming apparatus having a conventional waste toner container;

FIG. 2 is an elevational view diagram of an electrophotographic image forming apparatus according to an embodiment of the present invention;

FIG. 3 is a perspective view of an electrophotographic image forming apparatus having a waste toner container according to an embodiment of the present invention;

FIG. 4 is an elevational view in partial cross section of the waste toner container of FIG. 3 before being attached to an electrophotographic image forming apparatus; and

FIG. 5 is an elevational view in partial cross section of the waste toner container of FIG. 3 attached to an electrophotographic image forming apparatus.

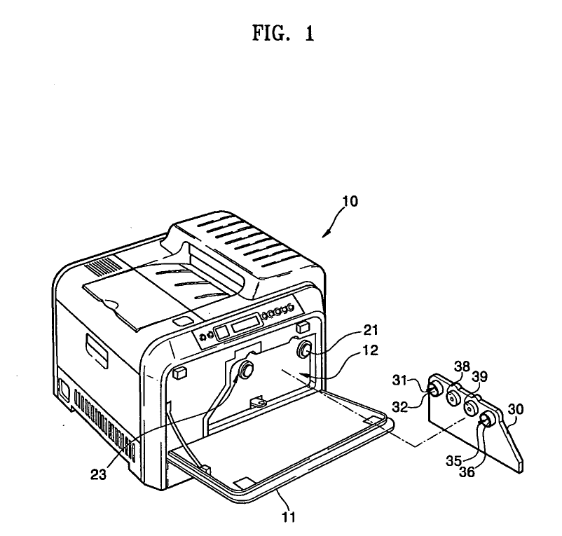

Throughout the drawings, like reference numerals will be understood to refer to like parts, components and structures.

### DETAILED DESCRIPTION OF THE INVENTION

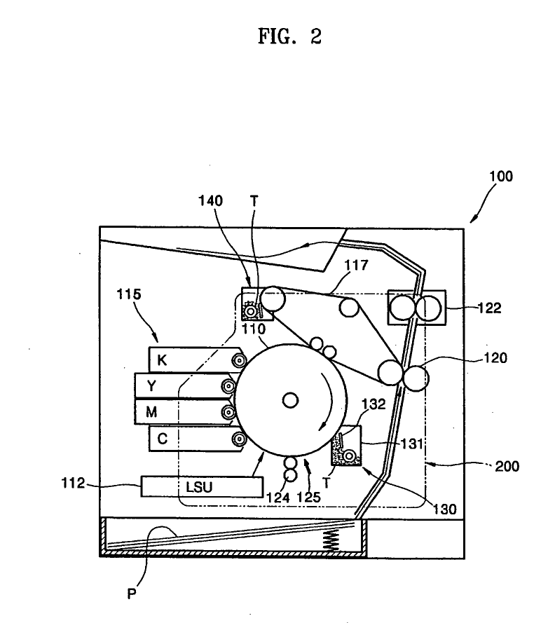

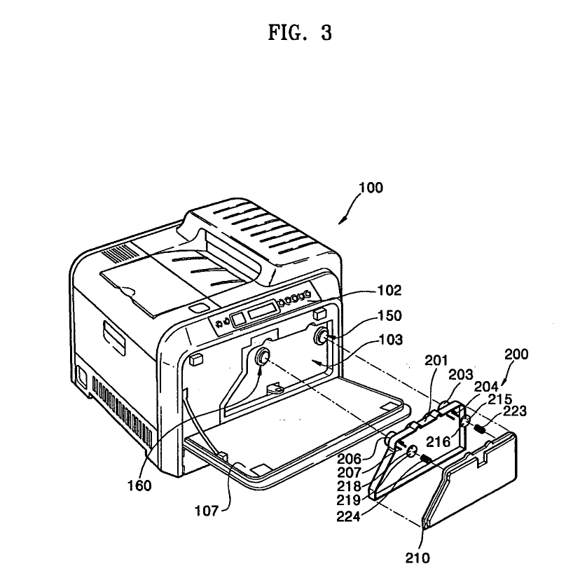

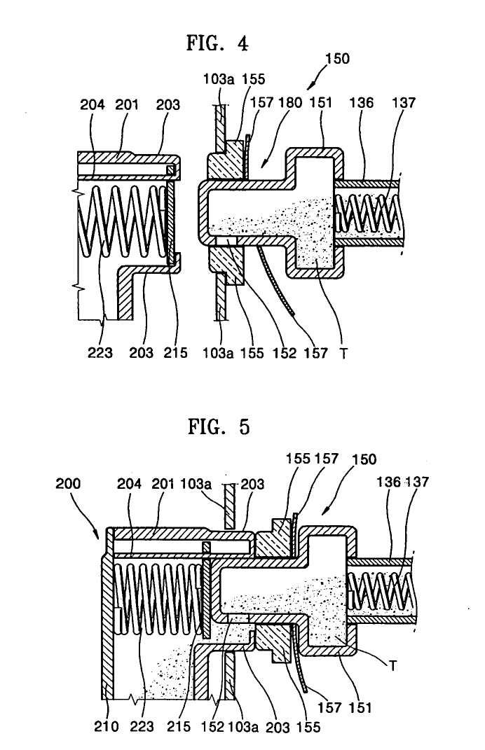

FIG. 2 is a diagram of an electrophotographic image forming apparatus according to an embodiment of the present invention. FIG. 3 is a perspective view of an electrophotographic image forming apparatus having a waste toner container according to an embodiment of the present invention. FIG. 4 is a sectional view of the waste toner container of FIG. 3 before being attached to an electrophotographic image forming apparatus. FIG. 5 is a sectional view of the waste toner container of FIG. 3 attached to an electrophotographic image forming apparatus.

According to an embodiment of the present invention, an electrophotographic image forming apparatus 100 includes a photoconductive drum 110, a light scanning unit 112, a developer 115, and a transfer belt 117.

The photoconductive drum 110, an example of a photoconductor, has a photoconductive material layer formed on an outer circumferential surface of a metallic drum. The light scanning unit 112 performs a light scanning operation on the photoconductive drum 110, which is charged with a uniform electric potential, to form an electrostatic latent image. The light corresponds to image information. A laser scanning unit (LSU), which typically uses a laser diode as a light source, may be used as the light scanning unit 112.

The developer 115 includes four developing components, 115C, 115M, 115Y, and 115K, which contain toner powders having colors of cyan C, magenta M, yellow Y, and black K, respectively. The developer 115 supplies the toners to the electrostatic latent image on the photoconductive drum 110 to form a toner image.

The transfer belt 117 is an example of an intermediate transfer medium that transfers the toner image from the photoconductive drum 110 to a printing medium P. The toner images having four colors of cyan C, magenta M, yellow Y, and black K, which are sequentially formed on the photoconductive drum 110, are transferred and superimposed to the transfer belt 117 to form a color toner image. The traveling speed of the transfer belt 117 is preferably the same as the rotational speed of the photoconductive drum 110. The transfer belt 117 is preferably the same length as or longer than the printing medium P.

Reference numeral 120 denotes a transfer roller. The transfer roller 120 is positioned to face the transfer belt 117. The transfer roller 120 is separated from the portion of the transfer belt 117 to which the color toner image is transferred by the photoconductive drum 110. After the color toner image is completely transferred to the transfer belt 117, the transfer roller 120 contacts the transfer belt 117 in a predetermined pressure to transfer the color toner image to a printing medium P. Reference numeral 122 denotes a fuser. When the printing medium P having the transferred toner image passes through the fuser 122, the toner image is affixed to the printing medium P by the application of heat and pressure. Reference numeral 124 denotes a charger for charging the photoconductive drum 110 with a uniform electric potential. Reference numeral 125 denotes an ionizer for removing electric charges remaining on the photoconductive drum 110.

An image forming process of the electrophotographic image forming apparatus 100 is as follows.

Color image information is a combination of information on each of the colors cyan C, magenta M, yellow Y, and black K. In an embodiment of the present invention, the color image is formed by superimposing a toner image for each of the colors cyan C, magenta M, yellow Y, and black K, preferably in this sequence on the transfer belt 117. The toner image is then transferred and affixed to the printing medium P.

In case of light corresponding to image information on cyan C, when the light scanning unit 112 performs a scanning operation of the light on the photoconductive drum 110 that is charged with a uniform potential, electric charges in a scanned portion on an outer circumferential surface of the photoconductive drum 110 reduce due to the decrease in resistance. Therefore, a potential difference arises between the scanned portion and a non-scanned portion, whereby an electrostatic latent image is formed on the outer circumferential surface of the photoconductive drum 110. When the electrostatic latent image approaches a developing component 115C as the photoconductive drum 110 rotates, toner having cyan C in the developing component 115C is attached to the electrostatic latent image to form a toner image having cyan C. When the toner image having cyan C approaches the transfer belt 117 as the photoconductive drum 110 rotates, the toner image is transferred to the transfer belt 117 by a potential difference between the photoconductive drum 110 and the transfer belt 117 or by pressure due to contact therebetween. After the toner image having cyan C is completely transferred to the transfer belt 117, toner images having magenta M, yellow Y, and black K are also superimposed and transferred to the transfer belt 117 through the same process as the toner image having cyan C, thereby forming a color toner image. When the printing medium P passes between the transfer belt 117 and the transfer roller 120, the color toner image is transferred to the printing medium P. Next, the color toner image is affixed to the printing medium P by the application of heat and pressure in the fuser 122, thereby completing the color image formation.

The photoconductive drum 110 and the transfer belt 117 are image holding units that hold the toner image temporarily before transferring to the printing medium P. In a process of transferring the toner image from the photoconductive drum 110 through the transfer belt 117 to the printing medium P, some toner remaining on the photoconductive drum 110 or the transfer belt 117 becomes waste toner. The waste toner remaining on the image holding units 110 and 117 should preferably be removed for the next printing medium.

According to an embodiment of the present invention, the electrophotographic image forming apparatus 100 includes a first cleaning unit 130 for removing the waste toner from the photoconductive drum 110, and a second cleaning unit 140 for removing the waste toner from the transfer belt 117. The first cleaning unit 130 includes a waste toner box 131, a blade 132 for scraping waste toner T while contacting with the photoconductive drum 110, and a carrier (not shown) for carrying the waste toner T from the waste toner box 131 to the waste toner container 200. In addition, the second cleaning unit 140 may have almost the same structure as the first cleaning unit 130.

The waste toner container 200 collects the waste toner T. When filled with the waste toner T, the waste toner container 200 is separated from the image forming apparatus 100 and disposed of in a proper way. While the waste toner may be put into the developer and reused, the waste toner is typically not reused in a color image forming apparatus since toners having each color are mixed together.

The waste container 200 comprises a first member 201 and a second member 210 whose edges are tightly sealed to each other to form a housing for collecting waste toner. First and second flanges 203 and 206 project outwardly from one side of the first member 201. First and second waste toner inlets, which the waste toner flows into, are provided at ends of the first and second flanges 203 and 206. First and second plugs 215 and 218 are provided in the housing. The first and second plugs 215 and 218 are elastically biased in the direction of closing the first and second waste toner inlets. First and second coil springs 223 and 224, which are mounted inside the housing, are means for elastically biasing the first and second plugs 215 and 218. One end of each of the first and second coil springs 223 and 224 is supported by the second member 210, and the other end is disposed in the housing to pressurize the first and second plugs 215 and 218.

The first and second plugs 215 and 218 are guided in the housing by guide means for an opening/shutting operation of the first and second waste inlets. The guide means include first and second guide protrusions 204 and 207 and first and second guide holes 216 and 219. The first and second guide protrusions 204 and 207 are projected in the housing toward the second member 210 from the vicinity of the first and second waste toner inlets at the ends of the first and second flanges 203 and 206. The first and second guide holes 216 and 219 are located on the first and second plugs 215 and 218, and first and second guide protrusions 204 and 207 pass therethrough.

The waste toner container 200 is attached to the concave waste toner container holding portion 103, which is accessible by opening a front door 107 of the electrophotographic image forming apparatus 100. The waste toner container holding portion 103 has first and second outlets that are closed by first and second cap units 150 and 160, respectively, to prevent waste toner from discharging. Waste toner carried from the first cleaning unit 130 is discharged from the first outlet, and waste toner from the second cleaning unit 140 is discharged from the second outlet.

The first cap unit 150 comprises a cap 151 and a ring-shaped sealing member 155. The cap 151 has an internal volume, and the sealing member 155 embraces an outer circumferential portion of a leading end of the cap 151 and is movably located on the cap. The sealing member 155 is elastically biased toward an inner wall 103a of the container holding portion 103 by a plate-like spring 157 to close the first outlet in the inner wall 103a of the container holding portion 103 and a waste toner outlet 152 is provided in the cap 151. Preferably, the waste toner outlet 152 is positioned in a leading end of the cap 151 and faces downwardly. A lower end of the spring 157 is preferably secured to a frame (not shown A tail end of the cap 151 is connected to a pipe 136 that carries waste toner T from the first cleaning unit 130 to the cap 151. A conveying coil 137 rotates within the pipe 136 to carry the waste toner T.

When the waste toner container 200 is separated from the image forming apparatus 100, the first plug 215, which is elastically biased by the first coil spring 223, closes the first flange 203 to close the first waste toner inlet. When the waste toner container 200 is inserted into the container holding portion 103, the first flange 203 pushes back the sealing member 155 to open the waste toner outlet 152. The waste toner T, which is delivered to the inside of the cap 151 through the pipe 136, is transferred to the waste toner container 200 through the opened waste toner outlet 152. At this time, the first plug 215 is substantially prevented from further movement by the leading end of the cap 151. If the waste toner container 200 is filled with the waste toner T, the waste toner container 200 is separated from the container holding portion 103. The first plug 215 is elastically moved by the first coil spring 223 to close the first waste toner inlet again, whereby the waste toner T in the waste toner container 200 is not discharged.

Meanwhile, since the second cap unit 160 has substantially the same structure as the cap unit 150, and a mechanism of carrying waste toner from the second cap unit 160 to the waste toner container 200 is also substantially the same as described above, the repeated description for the second cap unit 160 is omitted.

According to the present invention, an electrophotographic image forming apparatus has a waste toner container that substantially prevents waste toner from discharging by automatically closing a waste toner inlet when the waste toner container is separated from the image forming apparatus. Therefore, breakdown of the image forming apparatus, degradation of print quality, environmental pollution, and adverse effects on health due to discharged waste toner are substantially eliminated.

In addition, unlike in the prior art, a waste toner inlet does not need to be manually closed with a plug.

While the present invention has been described with reference to exemplary embodiments thereof, it will be understood by those skilled in the art that various changes in form and details may be made therein without departing from the scope of the present invention as defined by the following claims.

1. A waste toner container, comprising:
a housing to collect waste toner;
a flange extending outwardly from the housing;
a waste toner inlet disposed proximal an end of the flange through which the waste toner flows into the housing; and
a plug disposed in the housing and elastically biased in the direction of closing the waste toner inlet.

2. The waste toner container according to claim 1, wherein
the plug is guided in the housing by guide means.

3. The waste toner container according to claim 1, wherein
a guide protrusion extends inwardly into the housing in the vicinity of the waste toner inlet; and
a guide hole is disposed in the plug and through which the guide protrusion passes to guide the plug.

4. The waste toner container according to claim 1, wherein
the plug is elastically biased by a coil spring disposed in the housing.

5. The waste toner container according to claim 1, wherein
a pair of waste toner inlets are disposed in the housing to facilitate the flow of waste toner into the housing; and
a pair of plugs disposed in the housing are elastically biased in the direction of closing the pair of waste toner inlets.

6. The waste toner container according to claim 5, wherein
a guide protrusion extends inwardly into the housing in the vicinity of each of the waste toner inlets; and
a guide hole is disposed in each of the plugs and through which the guide protrusions pass to guide the plugs.

7. The waste toner container according to claim 5, wherein
a pair of springs are disposed in the housing to elastically bias the pair of plugs.

8. An electrophotographic image forming apparatus having a waste toner container to collect waste toner that is not transferred to a printing medium during a print process, the waste toner container comprising:
a housing to collect waste toner;
a flange extending outwardly from the housing;
a waste toner inlet disposed proximal anan end of the flange through which waste toner flows into the housing; and
a plug disposed in the housing and elastically biased in the direction of closing the waste toner inlet.

9. The electrophotographic image forming apparatus according to claim 8, wherein the plug is guided in the housing by guide means.

10. The electrophotographic image forming apparatus according to claim 8, wherein
a guide protrusion extends inwardly into the housing in the vicinity of the waste toner inlet; and
a guide hole is disposed in the plug and through which the guide protrusion passes.

11. The electrophotographic image forming apparatus according to claim 8, wherein
the plug is elastically biased by a coil spring disposed in the housing.

12. The electrophotographic image forming apparatus according to claim 8, wherein
a first waste toner inlet is disposed in the housing through which waste toner removed from a photoconductor flows into the housing;
a second waste toner inlet is disposed in the housing through which waste toner removed from an intermediate transfer medium flows into the housing; and
first and second plugs disposed in the housing are elastically biased in the direction of closing the first and second waste toner inlets.

13. The electrophotographic image forming apparatus according to claim 12, wherein
first and second guide protrusions extend inwardly into the housing in the vicinity of each of the first and second waste toner inlets; and
a first guide hole is disposed in the first plugs and a second guide hole is disposed in the second plug and through which the first and second guide protrusions pass to guide the first and second plugs.

14. The electrophotographic image forming apparatus according to claim 13, wherein
first and second springs are disposed in the housing to elastically bias the first and second plugs.

15. The electrophotographic image forming apparatus according to claim 8, wherein
the waste toner container is removably connected to the electrophotographic image forming apparatus.

16. A waste toner container, comprising:
a housing to collect waste toner having a first wall and a second wall opposite the first wall;
a first flange extending outwardly from the first wall of the housing;
a first waste toner inlet disposed proximal an end of the first flange through which the waste toner flows into the housing;
a first spring having a first end secured to the second wall of the housing; and
a first plug connected to a second end of the first spring and elastically biased in the direction of closing the first waste toner inlet.

17. The waste toner container according to claim 16, wherein
a second flange extends outwardly from the first wall of the housing;
a second waste toner inlet is disposed proximal an end of the second flange through which the waste toner flows into the housing;
a second spring has a first end secured to the second wall of the housing; and
a second plug is connected to a second end of the second spring and elastically biased in the direction of closing the second waste toner inlet.

18. The waste toner container according to claim 16, wherein
a first guide protrusion extends inwardly into the housing from an inner surface of the first flange; and
a first guide hole adapted to receive the first guide protrusion is disposed in the first plug.

19. The waste toner container according to claim 17, wherein
a first guide protrusion extends inwardly into the housing from an inner surface of the first flange;
a first guide hole is adapted to receive the first guide protrusion is disposed in the first plug;
a second guide protrusion extends inwardly into the housing from an inner surface of the second flange;
a second guide hole adapted to receive the second guide protrusion is disposed in the second plug.

20. The waste toner container according to claim 17, wherein
the first and second springs are coil springs.
